(19) United States
(12) Patent Application Publication
(10) Pub. No.: US 2020/0362476 A1
(43) Pub. Date: Nov. 19, 2020

(54) HYDROPHILIC AROMATIC POLYESTER-CONTAINING FIBERS, WEBS AND METHODS

(71) Applicant: 3M INNOVATIVE PROPERTIES COMPANY, St. Paul, MN (US)

(72) Inventors: Chetan P. Jariwala, Woodbury, MN (US); Hsin-Lung Tsai, St. Paul, MN (US); John A. Temperante, Woodbury, MN (US)

(21) Appl. No.: 16/947,580

(22) Filed: Aug. 7, 2020

Related U.S. Application Data
(62) Division of application No. 15/738,012, filed on Dec. 19, 2017.
(60) Provisional application No. 62/185,165, filed on Jun. 26, 2015.

(51) Int. Cl. D01F 6/92; D04H 1/435; C08L 67/02

(52) U.S. Cl. CPC D01F 6/92; C08L 2203/12; C08L 67/02; D04H 1/435

(57) ABSTRACT

Fibers, webs that include a plurality of such fibers, and methods of making such fibers, wherein each fiber includes a mixture including one or more aromatic polyesters and one or more organic polyester polymers, wherein the one or more organic polyester polymers have a molecular weight of 700 Daltons to 50,000 Daltons and comprises one equivalent weight of sulfonic acid groups or ionizable sulfonic acid salt groups per 700 to 8000 grams (of the organic polyester polymer).

### BACKGROUND

The Federal Trade Commission definition of a polyester fiber is “a manufactured fiber in which the fiber forming substance is any long-chain synthetic polymer composed of at least 85% by weight of an ester of a substituted aromatic carboxylic acid, including but not restricted to substituted terephthalic units, p(—R—O—CO—C₆H₄—CO—O—)ₓ, and parasubstituted hydroxy-benzoate units, p(—R—O—CO—C₆H₄—O—)ₓ.

Thermal comfort depends upon the heat release from the human body. Moisture release is one mechanism of heat loss. A person can release 1200 milliliters (mL) perspiration per hour in heavy activity from the Apocrine and Eccrine sweat glands. Cotton can absorb such perspiration (e.g., moisture regain is 7.0-8.5% at 65% Relative Humidity (RH)), whereas polyester, which is more hydrophobic in nature, cannot (e.g., polyester fiber moisture regain is only 0.4% at 65% Relative Humidity (RH)). Therefore, a person may experience or perceive discomfort when wearing polyester garments.

The rate at which water vapor moves through a fabric plays an important role in determining a person's comfort, as it influences the human perception and the cool/warmth feeling. This process is called moisture vapor transmission. A polyester fabric does not allow moisture on its surface, because of its hydrophobic nature, and therefore it cannot pass vapor easily through the pores of the fabric.

Attempts to improve water absorbency/hydrophilicity of a polyester fabric involves the following approaches: (1) use of a different spinning nozzle to make a differently shaped fiber; (2) use of hollow microporous fibers; (3) incorporation of two or three layers of hydrophilic fabric (e.g., cotton) with hydrophobic polyester fabric in a construction; and (4) applying a hydrophilic agent to the surface of hydrophobic fiber. Other methods are still needed to impart hydrophilicity to aromatic polyester-containing fibers.

### SUMMARY OF THE DISCLOSURE

The present disclosure provides hydrophilic aromatic polyester-containing fibers, webs that include a plurality of such fibers, and methods of making such fibers.

In one embodiment, the disclosure provides a fiber that includes a mixture including one or more aromatic polyesters and one or more organic polyester polymers, wherein the one or more organic polyester polymers have a molecular weight of 700 Daltons to 50,000 Daltons and comprises one equivalent weight of sulfonic acid groups or ionizable sulfonic acid salt groups per 700 to 8000 grams (of the organic polyester polymer).

In another embodiment, the disclosure provides a method of making fibers. The method includes: forming a melt mixture including: one or more aromatic polyesters; and one or more organic polyester polymers, wherein the one or more organic polyester polymers have a molecular weight of 700 Daltons to 50,000 Daltons and one equivalent weight of sulfonic acid groups or ionizable sulfonic acid salt groups per 700 to 8000 grams (of the organic polyester polymer); and forming a plurality of fibers from the melt mixture.

In certain preferred embodiments, the one or more organic polyester polymers of the mixture include residues that include:

a. 100 mol-% of one or more dicarboxylic acids, or derivatives thereof, comprising:

0 to 65 mol-% of one or more aliphatic dicarboxylic acids, or derivatives thereof, having at least 2 carbon atoms between carbonyl groups and having an average of 4 to 10 carbon atoms;

30 mol-% to 90 mol-% of one or more unsulfonated aromatic dicarboxylic acids, or derivatives thereof, of which at least 30 mol-% and up to 70 mol-% is terephthalic acid; and

5 mol-% to 60 mol-% of one or more aliphatic and/or aromatic dicarboxylic acids, or derivatives thereof, having 4 to 12 carbon atoms and having one or more sulfonic acid or ionizable sulfonic acid salt groups; and

b. 100 mol-% of one or more glycols including one or more aliphatic glycols having 2 to 10 carbon atoms and up to 4 non-peroxidic catenary oxygen atoms, wherein at least 30 mol-% of the aliphatic glycols is ethylene glycol.

The term “polymer” or “polymeric compound” includes compounds with at least 10 repeating units. This includes homopolymers and copolymers (with two or more kinds of monomeric units, including terpolymers, tetrapolymers, and the like).

The term “mixture” refers to the polyester polymer being incorporated in the bulk of a fiber (not merely as a coating on a fiber).

The term “residue” means that part of the original organic molecule remaining after reaction.

The term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to claims of the disclosure that may afford certain benefits, under certain circumstances. However, other claims may also be preferred, under the same or other circumstances. Furthermore, the recitation of one or more preferred claims does not imply that other claims are not useful, and is not intended to exclude other claims from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the phrases “at least one” and “one or more.” The phrases “at least one of” and “comprises at least one of” followed by a list refers to any one of the items in the list and any combination of two or more items in the list.

The term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

The term “room temperature” refers to a temperature of 20° C. to 25° C. or 22° C. to 25° C.

Herein, when a group is present more than once in a formula described herein, each group is “independently” selected, whether specifically stated or not. For example, when more than one Q group is present in a formula, each Q group is independently selected. Furthermore, subgroups contained within these groups are also independently selected.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### DETAILED DESCRIPTION OF ILLUSTRATIVE EMBODIMENTS

The present disclosure provides hydrophilic aromatic polyester-containing fibers, webs that include a plurality of such fibers, and methods of making such fibers. The fibers are formed from a mixture (typically, a melt mixture or melt blend) that includes one or more aromatic polyesters and one or more organic polyester polymers. In this context, a “mixture” refers to the polyester polymer being incorporated in the bulk of a fiber (not merely as a coating on a fiber).

In one embodiment, the disclosure provides a fiber that includes a mixture including one or more aromatic polyesters and one or more organic polyester polymers, wherein the one or more organic polyester polymers have a molecular weight of 700 Daltons to 50,000 Daltons (or 700 Daltons to 20,000 Daltons) and one equivalent weight of sulfonic acid groups or ionizable sulfonic acid salt groups per 700 to 8000 grams (of the organic polyester polymer).

In another embodiment, the disclosure provides a method of making fibers. The method includes: forming a melt mixture including: one or more aromatic polyesters; and one or more organic polyester polymers, wherein the one or more organic polyester polymers have a molecular weight of 700 Daltons to 50,000 Daltons (or 700 Daltons to 20,000 Daltons) and comprising one equivalent weight of sulfonic acid groups (—SO₃H groups) or ionizable sulfonic acid salt groups (such as —(SO₃)⁻M⁺ groups, where M⁺ is Li⁺, Na⁺, K⁺, and NR₃⁺ (wherein each R may be the same or different and each R is independently selected from H, C1-C18 alkyl groups, and CH₂CH₂OH)) per 700 to 8000 grams (of the organic polyester polymer); and forming a plurality of fibers from the melt mixture.

In certain embodiments, the mixture includes at least 90 percent by weight (wt-%), or at least 95 wt-%, or at least 98 wt-% of an aromatic polyester, or a combination of aromatic polyesters, based on the total weight of the mixture.

In certain embodiments, the mixture includes up to 99.9 percent by weight (wt-%), or up to 99.75 wt-% of an aromatic polyester, or a combination of aromatic polyesters, based on the total weight of the mixture.

In certain embodiments, the mixture includes at least 0.1 wt-%, or at least 0.25 wt-% of an organic polyester polymer, or a combination of organic polyester polymers, based on the total weight of the mixture.

In certain embodiments, the mixture includes up to 10 wt-%, or up to 5 wt-%, or up to 2 wt-% of an organic polyester polymer, or a combination of organic polyester polymers, based on the total weight of the mixture.

The addition of an organic polyester polymer in the bulk of the fiber provides fibers having stain-release properties defined by AATCC Test Method 130-2010, and absorbency defined by AATCC Test Method 79-2010. In certain embodiments, the level of stain release is represented by a rating of 6 or higher (such as 7 or higher) versus untreated fabric. In certain embodiments, the level of absorbency is represented by a wicking time of 20 seconds or less (such as 15 seconds or less, or 10 seconds or less, or 6 seconds or less, or 5 seconds or less, or 4 seconds or less, or 3 seconds or less, or 2 seconds or less, or 1 second or less, or even instantaneously upon contact of liquid to fabric), with water at a temperature of 41±3° C. (105±5° F.).

### Aromatic Polyesters

In certain embodiments, the aromatic polyester is selected from poly(ethylene) terephthalate (PET), poly(ethylene) terephthalate glycol (PETG), poly(butylene) terephthalate (PBT), poly(trimethyl) terephthalate (PTT), polypropylene terephthalate, and combinations thereof (including mixtures or copolymers thereof).

### Organic Polyester Polymers

In certain preferred embodiments, the one or more organic polyester polymers of the mixture includes residues that include:

a. 100 mol-% of one or more dicarboxylic acids, or derivatives thereof, comprising:

0 to 65 mol-% (or 0 to 45 mol-%) of one or more aliphatic dicarboxylic acids, or derivatives thereof, having at least 2 carbon atoms between carbonyl groups and having an average of 4 to 10 carbon atoms;

30 mol-% to 90 mol-% (or 40 mol-% to 70 mol-%) of one or more unsulfonated aromatic dicarboxylic acids, or derivatives thereof, of which at least 30 mol-% and up to 70 mol-% is terephthalic acid; and

5 mol-% to 60 mol-% (or 15 mol-% to 40 mol-%) of one or more aliphatic and/or aromatic dicarboxylic acids, or derivatives thereof, having 4 to 12 carbon atoms and having one or more sulfonic acid or ionizable sulfonic acid salt groups; and

b. 100 mol-% of one or more glycols comprising one or more aliphatic glycols having 2 to 10 carbon atoms and up to 4 non-peroxidic catenary oxygen atoms, wherein at least 30 mol-% (and typically up to 100 mol-%) of the aliphatic glycols is ethylene glycol.

Some of the organic polyester polymers useful in the present disclosure are disclosed in U.S. Pat. Nos. 3,779,993 and 4,052,368. The polyesters of the present disclosure are prepared by standard polyester preparative techniques involving the reaction of dicarboxylic acids, or derivatives thereof, including sulfo group-containing dicarboxylic acids, or derivatives thereof, with monoalkylene glycols. Herein, derivatives of dicarboxylic acids include diesters, diacid chlorides, and anhydrides.

In the final polyester polymer, 30 to 70 mole percent of the dicarboxylic acid residues are derived from terephthalic acid and at least 30 mole percent of the glycol residues are derived from ethylene glycol. The esterification reaction is carried out in the presence of acid catalysts (e.g. antimony trioxide), utilizing heat and pressure as desired. Normally, an excess of ethylene glycol is supplied and removed by conventional techniques in the later stages of polymerization. When desired, a hindered phenol antioxidant may be added to the reaction mixture to protect the polyester from oxidation. The polyesters obtained are having a ball-and-ring softening point in the range of 40° C. to 200° C. Generally, they are ground by conventional techniques and stored in containers sealed to exclude atmospheric moisture.

Acid residues as used herein refer to the species remaining after removal of the active hydrogens from the acid groups. Glycol residues refer to the species remaining after removal of the OH groups from the diols.

By “sulfo group” is meant a —SO₃X group in which X is hydrogen, an alkali metal cation (such as sodium, potassium, and lithium), an alkaline earth metal cation, or a tertiary or quaternary ammonium cation having zero to 18 carbon atoms (such as ammonium, hydrazonium, N-methyl pyridinium, guanidinium, methylammonium, butylammonium, diethylammonium, triethylammonium, tetraethylammonium, and benzyltrimethylammonium). Typically, monovalent cations are preferred. Examples of sulfo groups include sulfonic acid groups (—SO₃H groups) and sulfonic acid salt groups (such as —(SO₃)⁻M⁺ groups, where M⁺ is Li⁺, Na⁺, K⁺, and NR₃⁺ (wherein each R may be the same or different and each R is independently selected from H, C1-C18 alkyl groups, and CH₂CH₂OH).

Suitable sulfo-substituted dicarboxylic acids for preparation of the organic polyester polymers include: sulfoalkanedicarboxylic acids such as sulfosuccinic acid, 2-sulfoglutaric acid, 3-sulfoglutaric acid and 2-sulfododecanedioic acid; sulfoarenedicarboxylic acids such as 5-sulfoisophthalic acid, 2-sulfoterephthalic acid, 5-sulfonaphthalene-1,4-dicarboxylic acid; sulfobenzylmalonic acid esters such as those described in U.S. Pat. No. 3,821,281; sulfophenoxymalonate such as described in U.S. Pat. No. 3,624,034; and sulfofluorenedicarboxylic acids such as 9,9-di(2′-carboxyethyl)-fluorene-2-sulfonic acid. It is to be understood that the corresponding lower alkyl carboxylic esters of 4 to 12 carbon atoms, halides, anhydrides, and sulfo salts of the above sulfonic acids can also be used.

Suitable diols for condensation with the aforementioned sulfo-substituted dicarboxylic acids in preparing the organic polyester polymers are straight or branched chain alkylenediols having the formula HO—(CH₂)ₑ—OH in which e is 2 to 10, and oxaalkylenediols having a formula H—(OR)_{f}—OH in which R is an alkylene group having 2 to 4 carbon atoms and f is 2 to 4, the values being such that there are no more than 10 carbon atoms in the oxaalkylenediol. Examples of suitable diols include ethyleneglycol, propyleneglycol, 1,4-butanediol, 1,5-pentanediol, 1,6-hexanediol, 1,8-octanediol, 1,10-decanediol, 2,2-dimethyl-1,3-propanediol, 2,2-diethyl-1,3-propanediol, 3-methyl-1,5-pentanediol, diethyleneglycol, dipropyleneglycol, diisopropyleneglycol, 1,11-(3,6-dioxaundecane)diol, 1,14-(3,6,9,12-tetraoxatetradecane)diol, 1,8-(3,6-dioxa-2,5,8-trimethyloctane)diol, and 1,14-(5,10-dioxatetradecane)diol.

Small amounts of polyoxyalkylenediols having molecular weights up to 2000 may be included as reactants in the preparation of the polyester as long as the amount of polyoxyalkylenediol is kept below 10 mole percent and 10 weight percent.

Suitable aliphatic dicarboxylic acids having the formula HOOC—(CH₂)_{g}—COOH, wherein g has an average value of 2 to 8, are for example, succinic acid, adipic acid, maleic acid, glutaric acid, suberic acid, oxydipropionic acid, decanedioic acid, dodecanedioic acid, and 1,4-cyclohexanedicarboxylic acid. Diesters, particularly dimethyl esters, of these exemplary aliphatic dicarboxylic acids are also suitable for use in making the organic polyester polymers.

Useful aromatic dicarboxylic acids include terephthalic acid, isophthalic acid, phthalic acid, 1,4-naphthalenedicarboxylic acid, 1,2-naphthalenedicarboxylic acid, and 1,5-pyridine dicarboxylic acid. Diesters, particularly dimethyl esters, of these exemplary aromatic dicarboxylic acids are also suitable for use in making the organic polyester polymers.

To provide durability to the organic polyester polymer for use in the process of the disclosure, the dicarboxylic acids and diols are chosen so that at least 30 but not more than 70 mole percent of the total dicarboxylic acids in the final polyester is terephthalic acid. With less than 30 mole percent terephthalic acid, the polyester will typically not endure multiple laundering processes of the fibers. With more than 70 mole percent of terephthalic acid in the final polyester, the polyester becomes crystalline and therefore has insufficient stain-releasable finish durable through many washings.

### Optional Additives

Suitable additives to include in the mixture for making fibers include antioxidants (e.g., hindered light amine stabilizers, etc.), flame retardants, UV stabilizers, colorants (e.g., pigments or dyes), softeners, and antimicrobial agents, and combinations thereof. These optional additives could also be applied to the surface of the fibers and/or fabric.

### Fiber and Web Making Process

The present disclosure provides methods of making fibers, a plurality of which may be used to make yarns or threads. Such fibers, yarns, and/or threads may be incorporated into a fabric (e.g., textile or cloth), which may be formed by knitting, weaving, crocheting, knotting, or pressing (e.g., felt). A plurality of the fibers may be bonded together in at least point locations. Typical fabrics are knitted, woven, or nonwoven webs.

Fiber forming methods typically include melt extrusion. In accordance with known technology, such as continuous filament spinning for yarn or staple fibers, and nonwoven processes such as spunbond production and meltblown production, the fibers are formed by extrusion of the molten polymer through small orifices. In general, the fibers thus formed are then drawn or elongated to induce molecular orientation and affect crystallinity, resulting in a reduction in diameter and an improvement in physical properties. In nonwoven processes such as spunbonding and meltblowing, the fibers are directly deposited onto a foraminous surface, such as a moving flat conveyor and are at least partially consolidated by any of a variety of bonding means.

Preferred fiber forming methods include melt spinning. Exemplary melt spinning techniques are described in Handbook of Fiber Chemistry, Second Edition, M. Lewin and E. Pearce, ed., Chapter 1, pages 1-30 (1998).

It is known to those skilled in the art to combine processes or the fabrics from different processes to produce composite fabrics which possess certain desirable characteristics. Examples of this are combining spunbond and meltblown to produce a laminate fabric. Additionally either or both of these processes may be combined in any arrangement with a staple fiber carding process or bonded fabrics resulting from a nonwoven staple fiber carding process. In such described laminate fabrics, the layers are generally at least partially consolidated.

Nonwoven fabrics of the present disclosure may have a carded fiber structure or comprise a mat in which the fibers are distributed in a random array. The fabric may be formed and bonded by any one of numerous known processes including hydroentanglement or spun-lace techniques, or by air-laying or melt-blowing fibers, batt drawing, stitchbonding, etc., depending upon the end use of the article to be made from the fabric.

Extrusion temperatures for preparation of the fibers are typically in the range of from 285° C. to 300° C.

### Fiber Sizes

Fibers described herein may also be referred to as filaments. They typically have a circular cross-section, but may also have a non-circular cross-section, such as multilobal (e.g., trilobal or pentalobal), hexagonal, or irregular shape. Such fibers may be continuous or staple fibers.

In certain embodiments, the fibers of the present disclosure, which include filaments, typically have a median fiber diameter of no greater than 125 micrometers (μm), or no greater than 100 μm, or no greater than 80 μm, or no greater than 70 μ.

In certain embodiments, the fibers of the present disclosure, which include filaments, typically have a median fiber diameter of at least 10 micrometers (μm), or at least 20 μm.

In certain embodiments, the fibers of the present disclosure, which include filaments, typically have a fiber size of no greater than 100 denier (D), or no greater than 65 D, or no greater than 50 D, or no greater than 30 D.

In certain embodiments, the fibers of the present disclosure, which include filaments, typically have a fiber size of at least 1 denier (D), or at least 5 D.

The term “median fiber diameter” means fiber diameter determined by producing one or more images of the fiber structure, such as by using a scanning electron microscope; measuring the fiber diameter of clearly visible fibers in the one or more images resulting in a total number of fiber diameters, x; and calculating the median fiber diameter of the x fiber diameters. Typically, x is greater than 20, more preferably greater than 50, and desirably ranges from 50 to 200.

### EXEMPLARY EMBODIMENTS

Embodiment 1 is a fiber comprising a mixture comprising one or more aromatic polyesters and one or more organic polyester polymers, wherein the one or more organic polyester polymers have a molecular weight of 700 Daltons to 50,000 Daltons and comprises one equivalent weight of sulfonic acid or ionizable sulfonic acid salt groups per 700 to 8000 grams.

Embodiment 2 is the fiber of embodiment 1 wherein the one or more organic polyester polymers comprise residues comprising:

a. 100 mol-% of one or more dicarboxylic acids, or derivatives thereof, comprising:
0 to 65 mol-% one or more aliphatic dicarboxylic acids, or derivatives thereof, having at least 2 carbon atoms between carbonyl groups and having an average of 4 to 10 carbon atoms;
30 mol-% to 90 mol-% of one or more unsulfonated aromatic dicarboxylic acids, or derivatives thereof, of which at least 30 mol-% and up to 70 mol-% is terephthalic acid; and
5 mol-% to 60 mol-% of one or more aliphatic and/or aromatic dicarboxylic acids, or derivatives thereof, having 4 to 12 carbon atoms and having one or more sulfonic acid or ionizable sulfonic acid salt groups; and

b. 100 mol-% of one or more glycols comprising one or more aliphatic glycols having 2 to 10 carbon atoms and up to 4 non-peroxidic catenary oxygen atoms, wherein at least 30 mol-% of the aliphatic glycols is ethylene glycol.

Embodiment 3 is the fiber of embodiment 1 or 2 wherein the mixture comprises at least 90 wt-% and up to 99.9 wt-% of the one or more aromatic polyesters.

Embodiment 4 is the fiber of embodiment 3 wherein the mixture comprises at least 95 wt-% and up to 99.75 wt-% of the one or more aromatic polyesters.

Embodiment 5 is the fiber of embodiment 4 wherein the mixture comprises at least 98 wt-% and up to 99.75 wt-% of the one or more aromatic polyesters.

Embodiment 6 is the fiber of any one of embodiments 1 through 5 wherein the mixture comprises at least 0.1 wt-% and up to 10 wt-% of the one or more organic polyester polymers.

Embodiment 7 is the fiber of embodiment 6 wherein the mixture comprises at least 0.25 wt-% and up to 5 wt-% of the one or more organic polyester polymers.

Embodiment 8 is the fiber of embodiment 7 wherein the mixture comprises at least 0.25 wt-% and up to 2 wt-% of the one or more organic polyester polymers.

Embodiment 9 is the fiber of any one of embodiments 1 through 8 wherein the one or more aromatic polyesters are selected from poly(ethylene) terephthalate (PET), poly(ethylene) terephthalate glycol (PETG), poly(butylene) terephthalate (PBT), poly(trimethyl) terephthalate (PTT), poly(propylene) terephthalate, and combinations thereof (including mixtures and copolymers thereof).

Embodiment 10 is the fiber of any one of embodiments 1 through 9 wherein the one or more organic polyester polymers comprise residues comprising 0 to 45 mol-% of the aliphatic dicarboxylic acids, or derivatives thereof.

Embodiment 11 is the fiber of any one of embodiments 1 through 10 wherein the one or more organic polyester polymers comprise residues comprising 40 mol-% to 70 mol-% of the unsulfonated aromatic dicarboxylic acids, or derivatives thereof.

Embodiment 12 is the fiber of any one of embodiments 1 through 11 wherein the one or more organic polyester polymers comprise residues comprising 15 mol-% to 40 mol-% of the sulfonic acid-containing or sulfonic acid salt group-containing dicarboxylic acids, or derivatives thereof.

Embodiment 13 is the fiber of any one of embodiments 1 through 12 wherein the one or more organic polyester polymers have a molecular weight of 700 Daltons to 20,000 Daltons.

Embodiment 14 is the fiber of any one of embodiments 1 through 13 having stain-release properties defined by AATCC Test Method 130-2010, and absorbency defined by AATCC Test Method 79-2010. In certain embodiments, the level of stain release is represented by a rating of 6 or higher compared to untreated fabric, and the level of absorbency is represented by a wicking time of 20 seconds or less with water at a temperature of 41±3° C. (105±5° F.).

Embodiment 15 is the fiber of any one of embodiments 1 through 14 having a median fiber diameter of at least 10 μm and up to 125 μm or a fiber size of at least 1 Denier and up to 100 Denier.

Embodiment 16 is the fiber of any one of embodiments 1 through 15 wherein the fiber is a continuous or staple fiber.

Embodiment 17 is a web comprising a plurality of fibers of any one of embodiments 1 through 16.

Embodiment 18 is the web of embodiment 17 which is a woven, nonwoven, or knitted web.

Embodiment 19 is the web of embodiment 17 or 18 wherein the plurality of fibers are bonded together in at least point locations.

Embodiment 20 is a method of making fibers comprising:

forming a melt mixture comprising: one or more aromatic polyesters; and one or more organic polyester polymers, wherein the one or more organic polyester polymers haves a molecular weight of 700 Daltons to 50,000 Daltons and one equivalent weight of sulfonic acid or ionizable sulfonic acid salt groups per 700 to 8000 grams; and

forming a plurality of fibers from the melt mixture.

Embodiment 21 is the method of embodiment 20 wherein the one or more organic polyester polymers comprise residues comprising:

a. 100 mol-% of one or more dicarboxylic acids, or derivatives thereof, comprising:

0 to 65 mol-% of one or more aliphatic dicarboxylic acids, or derivatives thereof, having at least 2 carbon atoms between carbonyl groups and having an average of 4 to 10 carbon atoms;

30 mol-% to 90 mol-% of one or more unsulfonated aromatic dicarboxylic acids, or derivatives thereof, of which at least 30 mol-% and up to 70 mol-% is terephthalic acid; and

5 mol-% to 60 mol-% of one or more aliphatic and/or aromatic dicarboxylic acids, or derivatives thereof, having 4 to 12 carbon atoms and having one or more sulfonic acid or sulfinic acid salt groups; and

b. 100 mol-% of one or more glycols comprising one or more aliphatic glycols having 2 to 10 carbon atoms and up to 4 non-peroxidic catenary oxygen atoms, wherein at least 30 mol-% of the aliphatic glycols is ethylene glycol.

Embodiment 22 is the method of embodiment 20 or 21 further comprising forming a web from the fibers.

Embodiment 23 is the method of embodiment 22 wherein the web is a woven, nonwoven, or knitted web.

Embodiment 24 is the method of any one of embodiments 20 through 23 further comprising bonding the plurality of fibers together in at least point locations.

Embodiment 25 is the method of any one of embodiments 20 through 24 wherein the fibers are continuous or staple fibers.

### EXAMPLES

Objects and advantages of this disclosure are further illustrated by the following examples, but the particular materials and amounts thereof recited in these examples, as well as other conditions and details, should not be construed to unduly limit this disclosure. These examples are merely for illustrative purposes only and are not meant to be limiting on the scope of the appended claims.

### Test Methods

### Water Absorbency

Water absorbency was tested using AATCC Test Method 79-2010, “Absorbency of Textiles.”

This test measures the ability of a fabric to take up water. Prior to testing, the fabric samples were conditioned for 24 hours in a standard atmosphere having a relative humidity of 65%±2% at 21° C.±1° C. (70° F.±2° F.). Testing was performed under the same conditions. The fabric sample was placed in an embroidery hoop or similar device to suspend the fabric. Care was taken to make sure that the fabric is free of wrinkles or creases but without stretching or distorting the fabric. A burette or a medicine dropper was used to dispense one drop of distilled or deionized water (41±3° C. (105±5° F.)) onto the surface of the fabric from a distance of 10 mm below the tip of the burette or medicine dropper. A stopwatch was used to measure the time that it takes for the water drop to completely disappear (i.e., until the water drop absorbs completely). This was indicated by a loss of light reflectivity of the water drop (i.e., when it changes to a dull wet spot due the absorbent propensity of the fabric). The time was recorded to the nearest second. The reported values are an average of five tests. Shorter times indicate better absorbency. A value of “zero” in this test indicates that the water drop disappears immediately.

### Stain Release

Stain release was tested using AATCC Test Method 130-2010, “Soil Release: Oily Stain Release Method.”

This test evaluates the release of forced-in oil-based stains from the treated fabric surface during simulated home laundering. Prior to testing, the fabric samples were conditioned for at least 4 hours in a standard atmosphere having a relative humidity of 65%±2% at 21° C.±1° C. (70° F.±2° F.). Testing was carried out under the same conditions. Five drops of mineral were dropped onto the fabric surface in a single puddle and a separate puddle of 5 drops of corn oil was dropped on the fabric in separate area in the same general region of the fabric. The puddles were covered with glassine paper, and weighted with a 5 pound (2.3 kg) weight each for 60 seconds. The weights and glassine paper were removed from the fabric. The fabric sample was then blotted and hung for 15 to 60 minutes before washing and drying. Samples were evaluated against a rating board, and assigned a number from 1 to 8. A rating of 8 represents total removal of the stain, and a rating of 1 represents a very dark stain. The stain release test was carried out on treated fabric after initial treatment and after 5 consecutive launderings followed by tumble-drying.

### Laundry Cycles

The laundering procedure used for the laundry cycles was the machine washing and drying procedure described in AATCC Test Method 124-2011, “Smooth Appearance of Fabrics after Repeated Home Laundering.” This test method is designed to evaluate the smoothness appearance of flat fabric specimens after repeated home laundering, but it is also used when determining the durability of finishes applied on fabrics in the textile industry. A 12 minute wash cycle was used and the wash temperature used was 41±3° C. (105±5° F.). After the required number of washes, the samples and the ballast load were dried together in the tumble dryer on “heat” setting for 45±5 minutes; 65±6° C. (150±10° F.) maximum stack temperature.

### Examples of Organic Polyester Polymer 1-3

A sulfopolyester was prepared in accordance with Example 1 of U.S. Pat. No. 4,330,588.

### Preparation of Sulfopolyester/PET Masterbatch

In a typical procedure, the sulfopolyester was then pre-compounded into a 10 weight % sulfopolyester/90 weight % PET/masterbatch. The PET used was EASTLON PET CB-602 (obtained from Far Eastern New Century Corporation, Taipei, Taiwan). This was carried out using a 50 mm diameter fully intermeshing co-rotating twin screw extruder having conveying and kneading sections and having an L/D of 40 (Model PSM50, Sino-Alloy Machinery, Inc., Taiwan), fitted with a standard pelletizing die. The PET and the sulfopolyester were pre-compounded, blended, and fed into the twin screw extruder where the mixture was melted, mixed, and pumped through the extruder to the pelletizing die. The extruder had 3 temperature zones. The temperature of Zone 1 was set at 80-100° C. and the temperatures of Zones 2 and 3 and were set at 180-220° C. The EASTLON PET CB-602 was fed into Zone 1 at a feed rate of 30 kg/hour and the sulfopolyester was fed into Zone 1 at a feed rate of 6 kg/hour. The screw speed was set at 130 rpm and the die temperature was set at 220° C. The strands were run through a water bath and into a pelletizing puller, drained and dried as is known in the art.

### Preparation of Monofilament Fibers and Multifilament Yarn

Three (3) denier monofilament fibers were extruded using the masterbatch described above as a polymer melt additive blended with neat EASTLON PET CB-602 resulting in fibers that were comprised of 0.25, 0.5 and 1.5 weight % of the sulfopolyester. The extruder used to spin the fibers was a single screw extruder equipped with a screw having an L/D of about 32, a compression ratio of about 3 and a configuration as follows: feed zone; compression (plasticizing) zone; and a metering (pumping) zone. The extruder had several temperature zones beginning with a first zone temperature of 60-80° C. and subsequent zones of increasing temperatures of 180, 220, 235 and 270° C. The extruded polymer melt stream at 270° C. was pumped into a multi-orifice spinneret at a polymer throughput rate of 66 lbs/hour (30 kg/hour) and the line speed was maintained at 3000-3500 meters/minute. The 3 denier fibers were then simultaneously twisted and drawn (drawn down about 4 times, to about 1 denier) at a temperature of 200° C. and a line speed of 700 meter/minute to result in a drawn textured yarn (DTY) having a crimped, coiled or looped appearance along its length (75 denier yarn strand with 72 fibers per yarn strand).

The yarn was then knitted into fabric samples using a Model STN-1 Test Knitting Machine (available from Geeng Tyan Enterprises, Co., Ltd., Taipei, Taiwan). The gauge of the knitted fabric was 21 stitches per inch and the basis weight of the fabric was 110-120 grams/meter².

The knitted fabric samples were then tested for water absorbency and stain release using the test methods referenced above. The fabrics were scoured before testing to remove any processing aids (for example, lubricants) that may have been used in forming the fibers and yarns. Stain release data is based on a scale of 1 to 8, with a higher number indicating better stain release properties. Initial test results and test results after 5 laundry cycles are provided in Tables 1 and 2 below.

TABLE1

| | | After 5 |
|---|---|---|
| Water absorbency (in seconds) | Initial | laundry cycles |
| Control: neat PET (no sulfopolyester) | 20 seconds | 37 |
| Example 1: 0.25 weight % sulfopolyester | 6 | 17 |
| Example 2: 0.5% weight % sulfopolyester | 4 | 9 |
| Example 3: 1.0% weight % sulfopolyester | 2 | 6 |

TABLE 2

| | Initial | | After 5 laundry cycles | |
|---|---|---|---|---|
| Stain Release | Stain K¹ | Stain E² | Stain K | Stain E |
| Control: neat PET (no | 5 | 6 | 5.5 | 6 |
| sulfopolyester) | | | | |
| Example 1: 0.25 weight | 6 | 6.5 | 6.5 | 6.5 |
| % sulfopolyester | | | | |
| Example 2: 0.5% weight | 6 | 7 | 6.5 | 7 |
| % sulfopolyester | | | | |
| Example 3: 1.0% weight | 6 | 7 | 7 | 7 |
| % sulfopolyester | | | | |

¹Stain K = white mineral oil.
²Stain E = corn oil.

The test data shows that the fabric samples that were prepared from fibers/yarns that used the 10 weight-% sulfopolyester/90 weight-% PET masterbatch as a polymer melt additive gave improved water absorbency compared to fabric samples prepared without the polymer melt additive, while at the same time improving, or at least maintaining the stain release properties of the fabric.

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

What is claimed is:

1. A method of making fibers comprising:
forming a melt mixture comprising:
one or more aromatic polyesters; and
one or more organic polyester polymers having a molecular weight of 700 Daltons to 50,000 Daltons and comprising one equivalent weight of sulfonic acid groups or ionizable sulfonic acid salt groups per 700 to 8000 grams; and
forming a plurality of fibers from the melt mixture.

2. The method of claim 1 wherein the one or more organic polyester polymers comprise residues comprising:
a. 100 mol-% of one or more dicarboxylic acids, or derivatives thereof, comprising:
0 to 65 mol-% of one or more aliphatic dicarboxylic acids, or derivatives thereof, having at least 2 carbon atoms between carbonyl groups and having an average of 4 to 10 carbon atoms;
30 mol-% to 90 mol-% of one or more unsulfonated aromatic dicarboxylic acids, or derivatives thereof, of which at least 30 mol-% and up to 70 mol-% is terephthalic acid; and
5 mol-% to 60 mol-% of one or more aliphatic and/or aromatic dicarboxylic acids, or derivatives thereof, having 4 to 12 carbon atoms and having one or more sulfonic acid or sulfinic acid salt groups; and
b. 100 mol-% of one or more glycols comprising one or more aliphatic glycols having 2 to 10 carbon atoms and up to 4 non-peroxidic catenary oxygen atoms, wherein at least 30 mol-% of the aliphatic glycols is ethylene glycol.

3. The method of claim 1 further comprising forming a web from the fibers.

4. The method of claim 3 wherein the web is a woven, nonwoven, or knitted web.

5. The method of claim 1 further comprising bonding the plurality of fibers together in at least point locations.

6. The method of claim 1 wherein the mixture comprises at least 90 wt-% and up to 99.9 wt-% of the one or more aromatic polyesters.

7. The method of claim 1 wherein the mixture comprises at least 0.1 wt-% and up to 10 wt-% of the one or more organic polyester polymers.

8. The method of claim 1 wherein the one or more aromatic polyesters are selected from poly(ethylene) terephthalate (PET), poly(ethylene) terephthalate glycol (PETG), poly(butylene) terephthalate (PBT), poly(trimethyl) terephthalate (PTT), poly(propylene) terephthalate, and combinations thereof.

9. The method of claim 2 wherein the one or more organic polyester polymers comprise residues comprising 0 to 45 mol-% of the one or more aliphatic dicarboxylic acids, or derivatives thereof having at least 2 carbon atoms between carbonyl groups and having an average of 4 to 10 carbon atoms.

10. The method of claim 2 wherein the one or more organic polyester polymers comprise residues comprising 40 mol-% to 70 mol-% of the one or more unsulfonated aromatic dicarboxylic acids, or derivatives thereof.

11. The method of claim 2 wherein the one or more organic polyester polymers comprise residues comprising 15 mol-% to 40 mol-% of the one or more sulfonic acid group-containing or sulfonic acid salt group-containing dicarboxylic acids, or derivatives thereof.

12. The method of claim 1 wherein the one or more organic polyester polymers have a molecular weight of 700 Daltons to 20,000 Daltons.

13. The method of claim 1 wherein at least some of the fibers in the plurality of fibers have a fiber size of at least 1 Denier and up to 100 Denier.

14. The method of claim 1 wherein at least some of the fibers in the plurality of fibers have a median fiber diameter of at least 10 μm and up to 125 μm.
